(19) United States
(12) Patent Application Publication
(10) Pub. No.: US 2005/0241234 A1
(43) Pub. Date: Nov. 3, 2005

(54) Revolving door

(76) Inventor: Lothar Ginzel, Schwerte (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/518,069

(22) PCT Filed: Apr. 16, 2004
(86) PCT No.: PCT/EP04/04058

§ 371 Date: Dec. 14, 2004

(30) Foreign Application Priority Data
Apr. 17, 2003 (DE) 103 18 159.8

(51) Int. Cl. E05D 15/02

(52) U.S. Cl. 49/42

(57) ABSTRACT

Revolving door Comprising two stationary drum walls that are located diametrically opposite one another and with entrances and exits located therebetween, wherein the drum walls are attached to a ceiling construction covered by a front strip, wherein the drum walls and/or rotating leaf and/or a center rotating part to which the rotating leaves are attached are/is provided with profiles and panes of glass are held in the profiles, wherein lighting means are provided at least in one or more of the profiles.

The invention is directed to a revolving door according to the characterizing features of patent claim 1.

A revolving door which comprises two stationary drum walls located diametrically opposite one another and which has entrances and exits therebetween is known from DE 43 44 204 C1. A rotating part is provided inside the drum walls and has a drive motor. The rotating leaves which rotate around a centrally located center point inside the drum walls are attached to the drive motor. A front strip forms the upper closure of the drum walls and a roof construction is generally situated under the front strip. Depending on the construction of the revolving door, lamps which light the space between the drum walls are arranged inside a roof covering. There are two types of construction in this case. In one construction, the cover or ceiling participates in the rotation, meaning that there is a constant illumination inside the individual segments of the revolving door. In the other construction, in which the ceiling does not rotate along, the illumination is temporarily interrupted inside the individual segments by the rotating movement of the rotating leaves.

It is the object of the present invention to provide a revolving door which is improved with respect to its visual effect and which further offers a higher degree of safety particularly for older people.

This object is met through the features indicated in patent claim 1. Advantageous constructions of the subject matter of patent claim 1 are indicated in the subclaims.

By means of the indirect illumination of the individual panes of glass that are provided in the drum walls, rotating leaves and in the central rotating part, the safety potential is increased enormously at the same time in addition to the improved visual effect. The individual panes of glass can be lit with many different colors within different areas. Further, it is also possible that only the panes of glass of the rotating leaf in particular can change colors depending upon the person entering.

The lighting means are provided inside the profiles enclosing the glass panes or in the seals at the profiles. This enlivens the large-area elements of the glass panes and makes it possible to adapt better to different room situations.

According to an advantageous further development, the light enters via the edges of the glass panes. This not only produces an imaginative effect that can be further enhanced by providing the elements with patterns such as stripes, bubbles or the like, but also increases the optical effect when the light can be controlled in intensity. Through the use of correspondingly designed panes in which the light is refracted or by means of a corresponding etching of the surface or printing of the surface, a uniform light distribution can be achieved over the entire pane of glass.

The light can be introduced into the glass panes in a particularly simple manner when the lighting means are arranged in front of the glass edges of the individual glass panes. In this way, the light can be introduced directly in the plane of the pane of glass.

In order to protect the lighting means from harmful external influences such as water, moisture, etc., the profile and/or the seal in an advantageous further development have/has a cavity in which the lighting means, preferably an LED, is arranged. Instead of LEDs, other lighting means, preferably having a low energy consumption, can also be used.

Protection of the individual lighting means from external influences can be further improved in an advantageous further development when the cavity is filled with a sealing compound. This safely and reliably prevents the penetration of moisture and therefore prevents damage to the lighting means or even endangerment of the person using a revolving door.

According to a preferred embodiment form, the lighting means extend at least along part of the length of the glass panes, but preferably over the entire vertical length. Therefore, the lighting means are preferably provided only at the vertical or horizontal edges of the glass.

Further details, features and advantages of the invention are indicated in the following description of a preferred embodiment example with reference to the drawings.

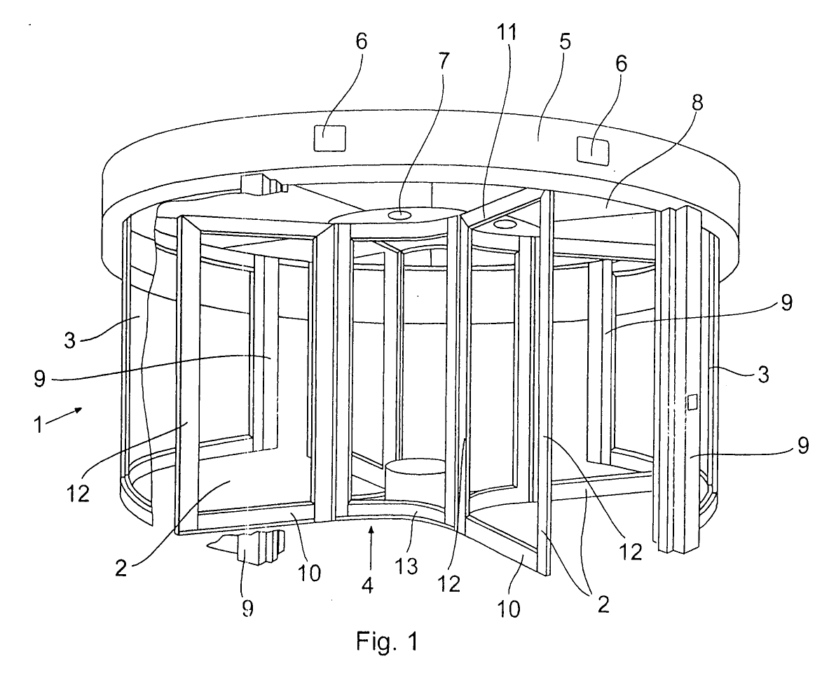

FIG. 1 shows an overall view of the revolving door;

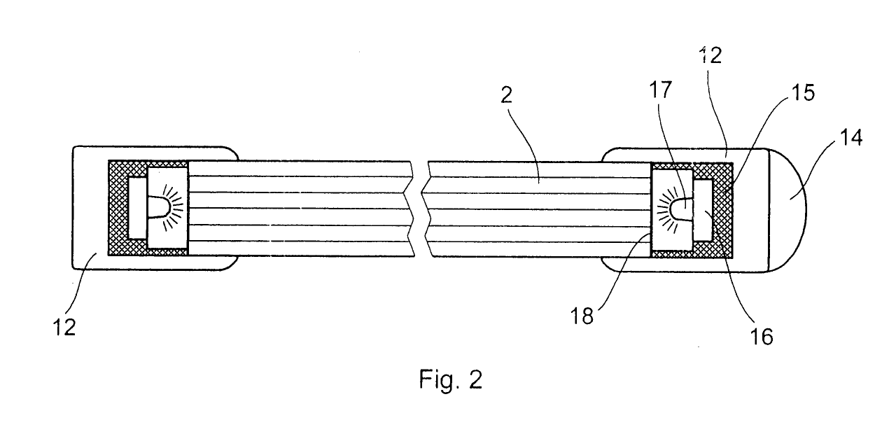

FIG. 2 shows a top view of an individual rotating leaf.

FIG. 1 shows a revolving door 1 comprising drum walls 3 which are located diametrically opposite one another and which terminate in a front strip 5 in the upper area. Below the front strip is a roof construction, not shown, which holds the revolving door 1 in its entirety. The drum walls 3 are constructed in such a way that they are defined laterally by closure profiles 9 in the entrance area and exit area and the curved glass panes are arranged therebetween. The curved glass panes can be divided into individual segments which are defined by corresponding profiles. A ceiling 8 forms the lower closure of the front strip 5. Sensors 6 are provided inside the front strip 5 for controlling the revolving door 1.

Lights 7 of a conventional type that can also be used as emergency lighting for a revolving door 1 of this type are located inside the ceiling 8.

A central rotating part 4 is set in rotation around a center axis, not shown, by means of an electromechanical drive, also not shown. The center rotating part 4 is framed by profiles 13 between which are located panes of glass, not shown in more detail. Depending on the embodiment form of the revolving door, different quantities of rotating leaves 2 adjoin the center rotating part 4. The rotating leaves 2 have a lower leaf profile 10 and an upper leaf profile 11 and profiles 12 arranged vertically therebetween. Depending on the embodiment form of the revolving door, the rotating leaves 2 can also be swiveled mechanically.

For the sake of clarity, only one of the rotating leaves 2 mentioned above is shown in FIG. 2. However, the following description relates to all other parts of the revolving door which have panes of glass framed by profiles. In particular, these parts are the drum walls 3, the rotating leaves 2 and the center rotating part 4.

The sectional top view of the leaf 2 in FIG. 2 shows the profile 12 on the left-hand side; this profile 12 is likewise present on the right-hand side, but is provided in this case with an additional seal 14. In this embodiment example, it should be noted that the arrangement of the lighting means can also go into the area of the seal 14.

Lighting means, formed as LEDs 17, adjoins a glass edge 18 of the pane of glass of the rotating leaf 2. The light radiated by the lighting means is accordingly directed to the glass edge 18. By means of the cavity around the LED, which consumes little energy, it is possible to achieve a uniform light distribution. A circuit board 16 to which the LEDs 17 are electrically connected is arranged on the side of the cavity remote of the glass edge 18. The LEDs 17 can be provided on at least one of the glass edges 18 of at least one of the panes of glass and extend along at least part of the length of the front edges. However, the arrangement of the LEDs 17 is especially effective when they are arranged along the entire vertical and/or horizontal extension of the glass edges 18 of the glass panes. The cavity inside the profile 12 in which the LEDs 17 are located is entirely or partially filled with a sealing compound 15 in order to protect against the penetration of moisture and to prevent damage.

The LEDs 17 can be provided with an additional circuit which makes it possible to vary the light radiated by the LEDs 17 with respect to the time during which they are turned on, brightness and/or color mixture. Further, the LEDs 17 can be controlled depending on the incident daylight, depending on the presence of a person or according to any other program.

### REFERENCE NUMBERS

1 revolving door
2 rotating leaf
3 drum wall
4 center rotating part
5 front strip
6 sensor
7 illumination
8 ceiling
9 closure profile
10 lower leaf profile
11 upper leaf profile
12 vertical leaf profile
13 profile frame
14 seal
15 sealing compound
16 circuit board
17 LED
18 glass edge

1-10. (canceled)

11. A revolving door comprising:
a pair of stationary diametrically opposed drum walls separated from each other by an entrance and an exit, each said drum wall comprising at least one pane of glass having vertical edges framed by closure profiles adjacent to said entrance and said exit;
a carousel located concentrically within said drum walls and comprising a rotatable central part and a plurality of leaves extending outward from said central part toward said drum walls, each said leaf comprising a pane of glass having horizontal and vertical edges framed by an upper profile, a lower profile, and a pair of vertical profiles; and
a light source provided in at least one of said profiles.

12. The revolving door of claim 11 further comprising a seal in at least one of said profiles, said light source being provided in said seal.

13. The revolving door of claim 11 wherein each said light source emits light into a respective edge of the glass pane.

14. The revolving door of claim 13 wherein each said light source faces a respective said edge of the glass pane.

15. The revolving door of claim 11 wherein said at least one of said profiles comprises a cavity in which said light source is located, said light source comprising a plurality of LEDs.

16. The revolving door of claim 15 wherein each said cavity is at least partially filled with sealing compound.

17. The revolving door of claim 11 wherein said light source is provided in each of said profiles and extends the length of each said edge.

18. The revolving door of claim 11 wherein said light source comprises a plurality of rows of LEDs arranged in respective said profiles and radiating light in different directions.

19. The revolving door of claim 11 wherein said light source comprises LEDs, said door further comprising a control which control at least one of brightness, period of illumination, and color mixture of the LEDs.

20. The revolving door of claim 19 wherein the control controls the LEDs depending on at least one of incident daylight and presence of a person.

21. The revolving door of claim 11 wherein said rotatable central part comprises at least one pane of glass having edges framed by at least one profile provided with a light source which emits light into a respective said edge.
